(19) United States
(12) Patent Application Publication
(10) Pub. No.: US 2004/0198364 A1
(43) Pub. Date: Oct. 7, 2004

(54) Method for assigning downlink radio frequencies in a frequency-reusing radio communications system

(76) Inventors: Yi-Wen Shih, Taipei City (TW); Hsin-Neng Hus, Tao-Yuan Hsien (TW); Hsi-Kun Chen, Tai-Chung City (TW); Hsu-Hsiang Tseng, Tao-Yuan Hsien (TW); Hueng-Ho Chen, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,933

(22) Filed: Aug. 30, 2002

(51) Int. Cl. H04Q 7/20

(52) U.S. Cl. 455/452.1; 455/62; 455/67.11

(57) ABSTRACT

A method for assigning downlink radio frequencies in a frequency-reusing radio communications system compares received signal strengths of radio frequencies to a predetermined threshold value, and assigns a radio frequency as a downlink radio frequency of a transmitter of a radio port if the received signal strength of the radio frequency is less than or equal to the predetermined threshold value. The threshold can be increased if no downlink radio frequency is assigned to the transmitter of the radio port. Radio ports that request a downlink radio frequency assignment can be queued, and downlink radio frequencies can be assigned until the queue of radio ports is empty. Downlink radio frequencies can also be assigned to radio ports by waiting until radio ports are not being used by a subscriber unit, or mobile phone user.

### BACKGROUND OF INVENTION

1. Field of the Invention

The present invention relates to radio communications system, and more specifically, to a method for assigning downlink radio frequencies in a frequency-reusing radio communications system.

2. Description of the Prior Art

Widely available mobile communications is one of the distinctive hallmarks of modern information-based society. Not long ago, mobile phones were too expensive for the average consumer to afford. Mobile phone coverage was limited and of poor quality. Service was either nonexistent outside of major metropolitan areas or at least unreliable. Primary users of mobile phones were large companies employing field staff and individuals who could afford the added expense and needed to make phone calls while on the go. However, it was expected that someday that most people would own and use a mobile phone, and it was simply a matter of time before the technology matured and the infrastructure was built to make personal mobile communications affordable.

Currently, the mobile communications industry is growing rapidly. Many individuals now own mobile phones, as the cost of one has become comparable to the cost of traditional landline telephone service. In fact, many people spend more time talking on their mobile phone than they do talking on their home phone. Mobile phones are a key element in modern business communications. Parents use them to keep in touch with their children. People in emergencies can use them to call for help. Additionally, with the development of hand held computers also comes the desire to be able to transfer data, such as information from the Internet, through the mobile phone communications system. Clearly, mobile phones have transformed the way people live.

Widespread mobile phone use is made possible by frequency-reusing radio communication systems. Such systems include radio ports located throughout the area to have mobile phone coverage. These radio ports are controlled by a centrally located control unit that is connected to the local wireline telephone network. Each radio port has a region, known as a cell, in which it transmits and receives information to and from individual mobile phones. Radio ports adjacent to each other transmit and receive signals on different frequencies to avoid interference and ambiguity as to which port is communicating with a given mobile phone. When a mobile phone user moves between radio port cells, the radio ports and the central control unit coordinate a handover. The geometry of a group of radio port cells is such that radio frequencies can be reused in the entire system provided that adjacent or near adjacent radio ports use different frequencies.

Typically, radio ports autonomously assign their own frequencies at a regular interval, which is in the order of once per day, to accommodate new radio ports added to the system and new sources of interference, such as a new building being constructed. A practical method for assigning radio frequencies to radio ports is taught by Chuang et al. in the comprehensive U.S. Pat. No. 5,212,831.

The prior art method of assigning radio frequencies as taught by Chuang et al. is summarized in FIG. 1, and is described as follows:

Step 100:Start;

Step 102:

A radio port to which a transmitting, or downlink, radio frequency is to be assigned turns off a transmitter;

Step 104:

A receiver of the radio port scans signals strengths of all available downlink frequencies;

Step 106:

The radio port selects the frequency with the lowest received power as its downlink frequency;

Step 108:The radio port is set to transmit on the selected downlink radio frequency;

Step 110:

Iterate the downlink frequency assignment process N times. The number of iterations N is a predetermined amount. Alternatively, the process can be iterated until the downlink frequency assigned does not change for a number of consecutive iterations;

Step 112:Wait a random delay before repeating the process;

Step 114:Done.

While the prior art method described was adequate in the past, it is becoming less efficient as mobile phones become increasingly popular. In a frequency-reusing radio communications system having a large number of radio ports and a large number of downlink frequencies, such as a mobile phone network in a high-density urban area, the above method may result in the same frequency being assigned to neighboring radio ports causing severe interference between the radio ports. Moreover, since the radio port cannot handle calls while it is undergoing downlink frequency assignment, the lack of efficiency in the above method causes considerable disruption in the performance of the system. Moreover, more time is required to assign frequencies to the radio ports.

Assigning downlink radio frequencies to radio ports according to the prior art is too time consuming and inefficient for modern high traffic communications systems.

### SUMMARY OF INVENTION

It is therefore a primary objective of the claimed invention to provide a method for assigning a downlink radio frequency to a transmitter of a radio port that is fast and efficient, and solves the problems of the prior art.

Briefly summarized, the claimed invention includes tuning a receiver of a radio port to a radio frequency, and measuring a received signal strength of the radio frequency. The claimed invention further includes comparing the received signal strength of the radio frequency to a predetermined threshold value, and assigning the radio frequency as a downlink radio frequency of the transmitter of the radio port if the received signal strength of the radio frequency is less than or equal to the predetermined threshold value.

According to the claimed invention, the above tuning, measuring, comparing, and assigning are repeated for other radio frequencies until a downlink radio frequency is assigned to the transmitter of the radio port. In addition, the predetermined threshold value can be increased by a predetermined amount if all of the available radio frequencies have been compared and a downlink radio frequency has not been assigned to the transmitter of the radio port.

According to the claimed invention, the method can further comprise queuing radio ports that request a downlink radio frequency assignment, and assigning downlink radio frequencies to each queued radio port after waiting a first delay and until the queue of radio ports is empty.

According to the claimed invention, the method can further comprise identifying radio ports that are not being used by a subscriber unit, or mobile phone user, and assigning downlink radio frequencies to each radio port after waiting a second delay and for all radio ports.

It is an advantage of the claimed invention that comparing received signal strengths of radio frequencies with the predetermined threshold allows a downlink radio frequency to be assigned quickly and efficiently as needless comparisons are not performed.

It is another advantage of the claimed invention that when a radio port is being used by a subscriber unit, it does interrupt transmission to assign a downlink radio frequency and service is not disrupted.

It is another advantage of the claimed invention that the first and second delays can be set to minimize redundant downlink frequency assignments, and in doing so making the method quick and efficient.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart of a prior art method of assigning a downlink radio frequency.

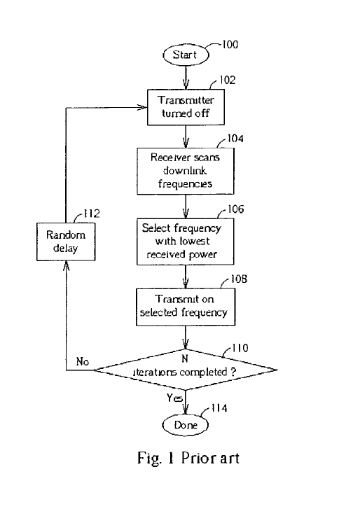

FIG. 2 is a schematic diagram of a mobile phone network.

FIG. 3 is a block diagram of a radio port circuit according to the present invention.

FIG. 4 is a flowchart showing a downlink frequency assignment of a radio port according to the present invention.

FIG. 5 is a flowchart showing the downlink frequency assignment of FIG. 4 performed on a plurality of queued radio ports.

FIG. 6 is a schematic diagram illustrating two RIF boards respectively managing two neighboring groups of radio ports.

FIG. 7 is a flowchart showing the downlink frequency assignment of FIG. 4 performed on a plurality of radio ports.

### DETAILED DESCRIPTION

The present invention will be described as applied to a mobile phone network. However, the teachings of the present invention can be used in other frequency-reusing communications systems such as systems for cordless phones, wireless data systems, and satellite communications systems. The application to a mobile phone network should not be construed as limiting the present invention.

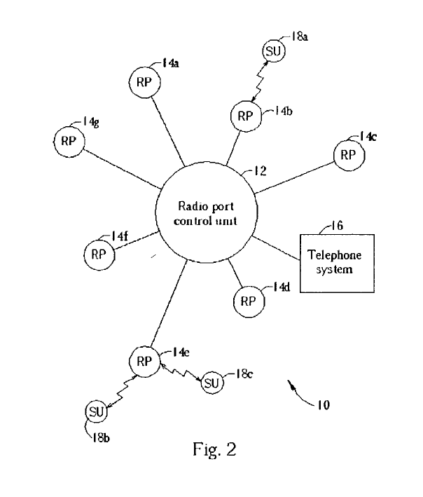

A mobile phone network 10 as illustrated in FIG. 2 comprises a radio port control unit (RPCU) 12 and a plurality of radio ports 14a-14g. Only seven radio ports 14a-14g are shown for clarity, however, a large-scale mobile phone networks can have hundreds. The RPCU 12 is connected to an existing wireline telephone system 16 by transmission lines. The RPCU 12 controls the radio ports 14a-14g and can activate, deactivate, issue commands to, and receive requests from each of the radio ports 14a-14g. In practical application, each radio port 14a-14g includes a transmission tower having a transmitter and several receivers, remote electronics at the tower, a transmission line connecting the tower to the RPCU 12, and further electronics located on a radio interface (RIF) board installed in the RPCU 12. Each RIF board of the RPCU 12 usually manages 16 radio ports, but more or less is also acceptable. Different radio port designs may include additional components, exclude some components listed above, or situate components at different locations. For the purposes of this description, the term radio port will be used to identify a device as described above, but the present invention should not be construed as limited by this.

Referring to FIG. 2, the radio ports 14a-14g communicate with thousands of mobile phones, termed subscriber units, of which three are illustrated as subscriber units 18a-18c. For instance, the subscriber unit 18b can place a call to the subscriber unit 18a, the subscriber unit 18c, or a customer of the landline telephone system 16. Each radio port 14a-14g uses a downlink radio frequency to transmit call information, such as digitally encoded voice transmission, to each active subscriber unit 18a-18c in its range or cell. Correspondingly, each subscriber unit 18a-18c is tuned to the downlink frequency of the particular radio port 14a-14g that is transmitting call information designated for that subscriber unit 18a-18c. In the network 10, these downlink frequencies are reused, and the strength of downlink radio signals is carefully controlled. This means that radio ports 14a-14g that are not neighboring to each other can use the same downlink radio frequency and still minimize interference. For example, the radio port 14b and the radio port 14e can transmit on the same downlink radio frequency. The subscriber unit 18a is only sensitive enough to receive signals from the radio port 14b, and the subscriber units 18b and 18c are likewise only sensitive enough to receive signals from the radio port 14e. The radio ports 14e and 14d must transmit on different downlink radio frequencies otherwise the subscriber unit 18c, which is about equidistant from the radio ports 14e and 14d, may receive incorrect call information. Additionally, corresponding uplink radio frequencies that are used to send call information from the subscriber units 18a-18c to the radio ports 14a-14g are assigned in conjunction with the downlink frequencies.

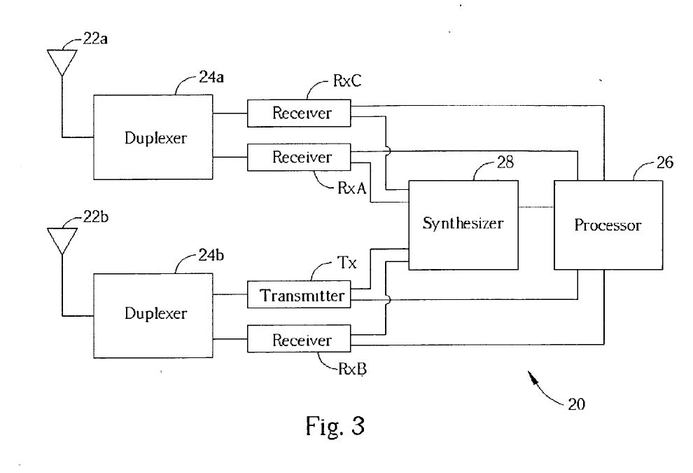

Each radio port 14a-14g includes a radio port circuit 20 as shown in FIG. 3. The radio port circuit 20 is connected to an RIF board in the RPCU 12. The radio port circuit 20 comprises two antennas 22a and 22b each connected to a corresponding duplexer 24a and 24b. Receivers RxC and RxA are connected to the duplexer 24a, and a transmitter Tx and a receiver RxB are both connected to the duplexer 24b. The receivers RxA and RxB are used to receive radio signals from subscriber units 18a-18c through the antennas 22a and 22b respectively and are normally active. The transmitter Tx is used to transmit the radio signals at the downlink radio frequency to subscriber units 18a-18c through the antenna 22b. The receiver RxC is a specialized receiver adapted to measuring signal strengths of radio signals transmitted by other radio ports 14a-14g. All the receivers RxA, RxB, RxC and the transmitter Tx can be turned on and off by a processor 26. The processor 26 can measure and compare the signal strengths of the radio signals received at the receiver RxC. The processor 26 can also control a synthesizer 28 to set the downlink radio frequency of the transmitter Tx, set a corresponding uplink frequency of the receivers RxA and RxB, as well as set a scan frequency of the receiver RxC.

The components of the radio port circuit 20 as described are in accordance with the preferred embodiment of the present invention and, naturally, other combinations of components having substantially the same functions could be used instead. For example, a similar radio port circuit could be designed with only a single transmitter, receiver, and antenna, the receiver being employed for both receiving radio signals from subscriber units and for scanning downlink radio frequencies of other radio ports. The construction of the radio port circuit 20 can be realized with readily available electronic components and IC circuits.

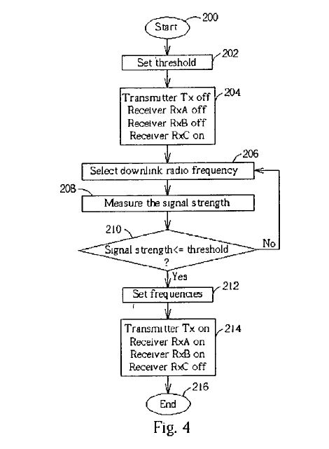

During normal operation, the receivers RxA and RxB and the transmitter Tx are turned on and active, and the receiver RxC is turned off. The receivers RxA and RxB receive radio signals on the uplink radio frequency from the subscriber units 18a-18c through the antennas 22a and 22b and duplexers 24a and 24b respectively. The transmitter Tx transmits radio signals on the downlink radio frequency to the subscriber units 18a-18c through the duplexer 24b and antenna 22b. Periodically, the downlink radio frequency needs to be reassigned in order to accommodate for new sources or interference, new constructions, and other factors. For a given radio port of the plurality of radio ports 14a-14g, the downlink radio frequency is assigned based on measurements of received downlink signal strengths from the other radio ports 14a-14g in the network 10, and the compassion of these measurements with a threshold value. Referring to FIG. 4, when the radio port circuit 20 of a radio port is to determine its downlink radio frequency on which the transmitter Tx is to transmit, the following procedure is executed:

Step 200:Start;

Step 202:

Set the threshold value to which the measured signal strengths of the received downlink radio frequencies are compared. The threshold value can be predetermined based of specific data, automatically determined and set by the radio port circuit 20, or set by the RPCU 12. The threshold value is stored in the memory (not shown);

Step 204:

The processor 26 turns off the transmitter Tx and the receivers RxA and RxB, and turns on the receiver RxC. The receivers RxA and RxB are turned off to avoid interference;

Step 206:

The processor selects a downlink radio frequency for the receiver RxC to measure;

Step 208:

The receiver RxC, as controlled by the processor 26, measures the signal strength of the downlink radio frequency;

Step 210:

The processor 26 compares the measured signal strength of the downlink radio frequency to the threshold value. Is the signal strength less than or equal to the threshold value? If it is, proceed to step 212, if it is not, then return to step 206 to try a different frequency;

Step 212:

The processor 26 controls the synthesizer 28 to set the downlink radio frequency of the transmitter Tx to the frequency last measured, i.e. the frequency that was determined to have a signal strength less than or equal to the threshold value. The receivers RxA and RxB are set to receive signals on the corresponding uplink radio frequency. Of course, if the downlink frequency does not need to be changed this setting step is omitted;

Step 214:

The processor 26 turns on the transmitter Tx and the receivers RxA and RxB, and turns off the receiver RxC. The transmitter Tx is now ready to transmit at the set downlink radio frequency and the receivers RxA and RxB are ready to receive at the set uplink radio frequency;

Step 216:End.

The scanning order of the downlink radio frequencies and the first frequency scanned can be adjusted to minimize the total number of measurements and comparisons required, thus minimizing the time required to determine a suitable downlink radio frequency. If all of the valid downlink radio frequencies used in the network 10 are scanned and no frequency was found to have a signal strength less then or equal to the threshold value, the threshold value is increased and the above procedure is repeated. The amount that the threshold value is increased by can be fine-tuned to suit the specific needs of the network 10. The threshold value is increased and the above procedure is repeated until a downlink radio frequency is assigned to the transmitter Tx.

One suitable way of comparing the downlink radio signal strengths received by receiver RxC to the threshold value is by determining received signal strength indication (RSSI) values. Briefly summarized, determining an RSSI from received downlink radio signals involves converting the signals into voltage levels, converting the voltages into digital signals, and averaging the digital signals. Typically, the circuitries required are an RF module and a baseband module capable of outputting digital signals representative of the received signal strength, and a digital averaging circuit. The averaged value can then be compared to a threshold value. Of course, other ways of comparing the downlink radio signal strengths received by receiver RxC to the threshold value are also possible.

The downlink radio frequency assignment procedure of FIG. 4 can be initiated and controlled by an outside source such as the RPCU 12, and can be autonomous so that a radio port of the plurality of radio ports 14a-14g executes the above procedure at a given time or under specific circumstances. For instance, a radio port can be programmed to execute the above procedure if it has remained inactive, handling no calls, for a certain period of time. On the other hand, the RPCU 12 can coordinate the execution of the above procedure in numerous different ways, two of which are described hereinafter.

The above-described procedure of FIG. 4 for assigning a downlink radio frequency to the transmitter Tx of a single radio port can be performed for the plurality of radio ports 14a-14g in many ways. One of such ways is by performing the above-described procedure for radio ports of the plurality of radio ports 14a-14g that belong to the same RIF board and that request a downlink frequency assignment. This situation can occur if a new RIF board is installed into the RPCU 12 and a new group of radio ports comes online.

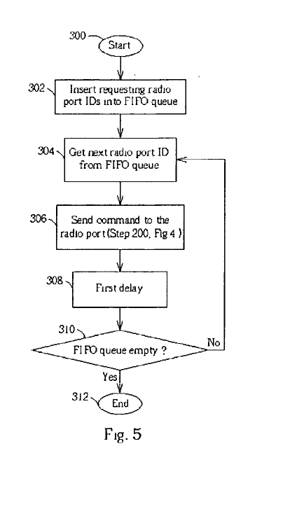

Referencing FIG. 5, the downlink frequency assignments for a group of radio ports belonging to a RIF board can occur in accordance with a first-in first-out (FIFO) basis as follows:

Step 300:Start;

Step 302:

The RPCU 12 inserts an identification number of any radio port requesting a downlink frequency assignment into a FIFO queue;

Step 304:

The RPCU 12 gets the next radio port identification number from the FIFO queue;

Step 306:

The RPCU 12 sends a downlink frequency assignment command to the radio port corresponding to the radio port identification number pulled from the FIFO queue. Accordingly, the radio port circuit 20 of the radio port executes the previously described procedure, in FIG. 4 beginning at step 200, to determine a suitable downlink radio frequency;

Step 308:

A first delay is waited while the radio port circuit 20 of the radio port determines a suitable downlink radio frequency for the transmitter Tx. The first delay is long enough to ensure that multiple radio ports are not determining the same downlink radio frequency at the same time so that redundant frequency assignments are avoided;

Step 310:

Is the FIFO queue empty? If there are more radio ports queued for receiving a downlink radio frequency assignment, return to step 304. If the FIFO queue is empty, go to step 312;

Step 312:End.

The first delay of step 308 is set so that only one radio port is performing the downlink radio frequency assignment procedure at a given time. Specifically, when the radio port circuit 20 of the selected radio port is using receiver RxC to scan downlink radio frequencies and the transmitter Tx is accordingly turned off, it is preferable to have the transmitters Tx of all the other radio ports in the network 10 active to ensure accurate measurements of downlink radio frequency signal strengths. The first delay can be fixed or variable depending on the properties of the mobile phone network 10, with the desired result being that the radio ports 14a-14g perform the downlink radio frequency assignment procedure one at a time.

This means that radio ports 14a-14g that are not neighboring to each other can use the same downlink radio frequency and still minimize interference.

A way of assigning downlink radio frequencies to a group of radio ports is to cycle through the plurality of radio ports 14a-14g and assign downlink radio frequencies when radio ports 14a-14g are not being used by a mobile phone customer or subscriber unit 18a-18c. This type of procedure is periodically required to update the downlink radio frequencies of the radio ports 14a-14g as the urban landscape changes and new sources of interference come about, and as the network 10 grows and more and more radio ports are added to improve network coverage.

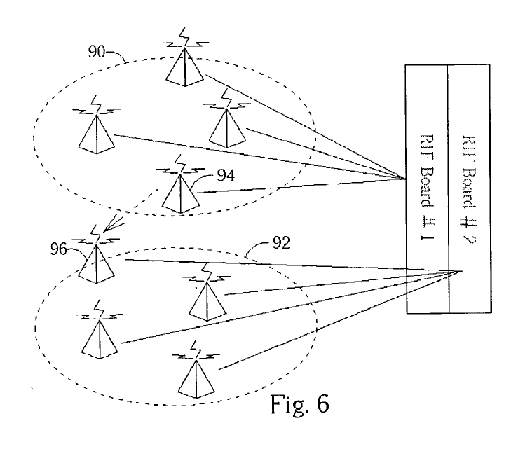

Please refer to FIG. 6, which shows two RIF boards respectively managing two neighboring groups 90, 92 of radio ports. Because two radio ports 94, 96 may select approximately the same downlink radio frequency to communicate with mobile phones, interference will appear between this two radio ports 94, 96. A following flow chart attempts to solve this problem.

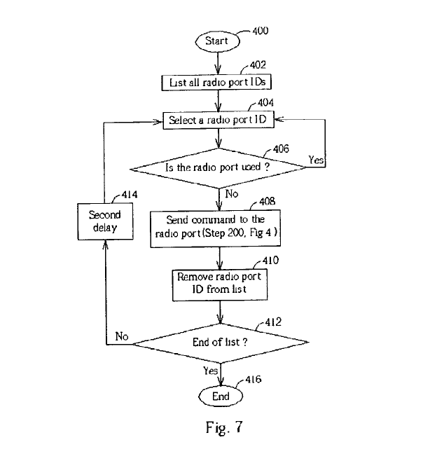

Referencing FIG. 7, the downlink radio frequency assignments for the radio ports 14a-14g when not being used by a subscriber unit 18a-18c can occur in a sequential manner as follows:

Step 400:Start;

Step 402:

The RPCU 12 compiles a list of radio port identification numbers of all radio ports 14a-14g;

Step 404:

The RPCU 12 selects a next radio port identification number from the list. The selecting is done in a sequential manner from the beginning of the list to the end of the list;

Step 406:

The RPCU 12 determines if the radio port corresponding to the selected radio port identification number is currently being used by a mobile phone customer or subscriber unit 18a-18c. If the radio port is being used, then return to step 404. If the radio port is not being used, then go to step 408;

Step 408:

The RPCU 12 sends a downlink radio frequency assignment command to the radio port corresponding to the radio port identification number selected from the list. Accordingly, the radio port circuit 20 of the radio port executes the previously described procedure, in FIG. 4 beginning at step 200, to determine a suitable downlink radio frequency;

Step 410:Remove the selected radio port identification number from the list;

Step 412:

The RPCU 12 determines if all radio ports not being used by a subscriber unit have had a downlink frequency assigned. Is the list of radio port identification numbers empty? If the list is empty then go to step 416, and if it is not then go to step 414;

Step 414:A second delay is waited to allow the network 10 to stabilize;

Step 416:End.

Normally, the RPCU 12 will execute the above procedure once during a 24-hour period. As a radio port cannot transmit to or otherwise communicate with subscriber units while it is determining a downlink radio frequency, a suitable time for executing the above procedure is the early hours of the morning such as 2:00 AM or 3:00 AM. However, other time frames may be used to execute the above procedure. During this time, a low amount of mobile phone calls is made so potential service disruptions are minimized. Obviously, step 406 in the above procedure makes certain that a call will not be interrupted, however, new calls cannot be placed while a radio port is determining a downlink radio frequency. In fact, the time required to complete the above procedure depends directly on how many radio ports are in use. Naturally, the RPCU 12 can execute the above procedure at any time convenient and with a second delay of any length. In a preferred way, all the radio ports 14a-14g in the network 10 are controlled to determine a downlink radio frequency over one entire day by executing the above procedure once in that day and by setting the second delay to a value of about 3.4 hours (24 hours divided by 7 radio ports 14a-15g). Essentially, how often the RPCU 12 executes the above procedure and the length of the second delay can be adjusted to meet the specific requirements of the network 10.

The above-described procedure has the advantage of responding quickly to radio ports that are not functioning correctly. For instance, if 90% of the radio ports in the network 10 are functioning correctly and 10% cannot provide service because of interference, the procedure will quickly reassign frequencies to those 10% first as they are not being used (step 406). Therefore, when the network 10 is busier, such that the majority of functioning radio ports are being used, the procedure above responds more quickly to malfunctioning radio ports. Moreover, when the procedure reassigns a frequency to a malfunctioning radio port, a neighboring malfunctioning radio port is likely to begin functioning correctly without any additional frequency assignment. This is because interference between radio ports, i.e. radio ports transmitting on the same downlink frequency, in the network 10 usually occurs between neighboring ports. Thus, if 10% of the radio ports cannot provide service because of interference, the above procedure simply only needs to reassign frequencies to about 5% of them.

The possibility exists that after executing the queuing procedure as illustrated in FIG. 5 or the above procedure as illustrated in FIG. 7 the downlink radio frequencies of the radio ports 14a-14g may not be optimally assigned. That is, there is another arrangement of downlink radio frequencies for the radio ports 14a-14g that further minimize interference between the radio ports 14a-14g. Therefore, these procedures can be repeated. Such repetition can follow a predetermined logic such as repeating for a predetermined number of times or repeating until no radio port has a new downlink radio frequency assigned for a predetermined number of repeats.

The present invention method has a simple design with minimal use of system resources. Radio ports are assigned downlink frequencies without disrupting service and causing inconvenience to customers (subscriber units). Furthermore, over time, the present invention method progressively optimizes network performance.

In contrast to the prior art, the present invention method compares measured signal strengths of downlink radio frequencies to a threshold value and sets the downlink radio frequency of a transmitter of a radio-port to a downlink radio frequency that has a signal strength less than or equal to the threshold value. This allows a downlink radio frequency to be assigned quickly and efficiently, as unnecessary comparisons are not performed. Furthermore, the present invention can perform downlink frequency assignments to a group of radio ports that request a downlink frequency assignment, or sequentially to all ports when they are not being used by subscriber units. In doing this, service disruptions are minimized. Finally, the present invention has a first delay and a second delay that can be set to minimize redundant downlink frequency assignments, and in so doing making the method quick and efficient.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for assigning a downlink radio frequency to a transmitter of a radio port served by a radio interface (RIF) board of a radio port control unit (RPCU) in a frequency-reusing radio communications system serving a plurality of subscriber units, the frequency-reusing radio communications system having a plurality of radio frequencies, the method comprising:
(a) tuning a receiver of the radio port to a radio frequency;
(b) measuring a received signal strength of the radio frequency;
(c) comparing the received signal strength of the radio frequency to a predetermined threshold value; and
(d) assigning the radio frequency as a downlink radio frequency of the transmitter of the radio port if the received signal strength of the radio frequency is less than or equal to the predetermined threshold value.

2. The method of claim 1 further comprising:
(e) repeating (a) through (d) for other radio frequencies until a downlink radio frequency has been assigned in (d) to the transmitter of the radio port, and increasing the predetermined threshold value by a predetermined amount if all of the plurality of radio frequencies have been compared in (c) and a radio frequency has not been assigned in (d) as the downlink radio frequency of the transmitter of the radio port.

3. The method of claim 2 further comprising:
(f) queuing radio ports that request a downlink radio frequency assignment; and
(g) repeating (a) through (e) for each queued radio port after a first delay until the queue of radio ports is empty.

4. The method of claim 3 wherein the queuing (f) is performed on a first-in first-out (FIFO) basis independently for each of a plurality of RIF boards.

5. The method of claim 3 wherein the RPCU controls (f) and (g).

6. The method of claim 2 further comprising:
(h) identifying radio ports that are not being used by a subscriber unit; and
(i) repeating (a) through (h) after a second delay for all radio ports that are not being used by a subscriber unit until every radio port has a downlink radio frequency assigned in (d).

7. The method of claim 6 further comprising:
(j) repeating (h) and (i) a predetermined number of times.

8. The method of claim 6 further comprising:
(k) repeating (h) and (i) until no transmitter of a radio port is set to a new downlink radio frequency for a predetermined number of consecutive repeats of (h) through (i).

9. The method of claim 6 wherein in (h) and (i) the plurality of radio ports is cycled through in a sequential manner.

10. The method of claim 6 wherein the RPCU controls (h) and (i).

11. The method of claim 1 further comprising:
(j) turning off the transmitter of the radio port while performing (a) through (d).

12. The method of claim 1 wherein (d) further comprises assigning an uplink radio frequency to another receiver of the radio port.
